(19) United States
(12) Patent Application Publication
(10) Pub. No.: US 2013/0254725 A1
(43) Pub. Date: Sep. 26, 2013

(54) EXTRACTION OF IMAGING PARAMETERS FOR COMPUTATIONAL LITHOGRAPHY USING A DATA WEIGHTING ALGORITHM

(71) Applicant: TEXAS INSTRUMENTS INCORPORATED, Dallas, TX (US)

(72) Inventor: ASHESH PARIKH, FRISCO, TX (US)

(73) Assignee: Texas Instruments Incorporated, Dallas, TX (US)

(21) Appl. No.: 13/849,301

(22) Filed: Mar. 22, 2013

Related U.S. Application Data
(60) Provisional application No. 61/614,962, filed on Mar. 23, 2012.

(51) Int. Cl. G06F 17/50

(52) U.S. Cl. CPC G06F 17/50
USPC 716/53

(57) ABSTRACT

A method of computational lithography includes collecting inline post-develop resist critical dimension (CD) data obtained from printing a test structure having resist on a substrate having a layer thereon using a mask including a set of gratings having main features and resolution assist features (RAFs) in proximity to the main features. The RAFs include a size range so that a lithography system used for the printing prints some of the RAFs, while some of the RAFs do not print. A plurality of resist kernels are determined from the post-develop resist CD data including a non-Gaussian developer etching kernel which represents a developer used for the printing and a Gaussian kernel. A resist model is generated which provides a resist image contour from an aerial image contour and the plurality of resist kernels.

### CROSS-REFERENCE TO RELATED APPLICATIONS

This application claims the benefit of Provisional Application Ser. No. 61/614,962 entitled “SYSTEM AND METHOD TO CALIBRATE MULTIPLE DENSITY KERNELS TO BE USED FOR OPC”, filed Mar. 23, 2012, which is herein incorporated by reference in its entirety.

### FIELD

Disclosed embodiments relate to integrated circuits (ICs) including semiconductor fabrication, and more particularly to computational lithography for forming IC devices and IC devices therefrom.

### BACKGROUND

Analog ICs generally need a high degree of precision in terms of local parametric matching as well as matching across the die. A modern patterning process which transfers a circuit design from a reticle (or mask) to a layer (e.g., polysilicon or metal) on a substrate surface (e.g., Si) using optical lithography undergoes multiple process steps such as lithography imaging and develop etching of a resist, followed by plasma and/or wet etching to form the features, and then chemical cleans for removal of residual resist polymers. All these process steps impact cumulatively on the dimensions of devices, such as transistors and circuit elements including resistors and capacitors, and thus IC parameters dependent thereon, depending on the pattern density in the recticle.

The workhorse to enable sub-wavelength lithography is referred to as computational lithography (CL). CL makes use of numerical simulations to improve the performance (resolution and contrast) provided by cutting-edge reticles. CL combines techniques including Resolution Enhancement Technology (RET) and Optical Proximity Correction (OPC), and some non-optical portions. Beyond the models used for RET and OPC, CL can include the signature of the scanner to help improve accuracy of the OPC model, polarization characteristics of the lens pupil, a Jones matrix of the stepper lens, optical parameters of the resist stack, and a model for diffusion through the resist.

Generally, processes such as for the transistor active area, gate electrode and metal processes are modeled by collecting empirical (inline) critical dimension (CD) data only after both the resist patterning and the etching process which together define the resulting structures. Heuristic threshold-based CL models are formed using convolution of an aerial image (AI) and Gaussian kernels representing photoacid diffusion in resists and other process-related effects by training them (fitting the model with “thresholds”) to the empirical data using statistical methods. Such threshold-based models have been used over several process nodes. In this form, the modeling accuracy is proportional to the number of sampling functions used, with a trade-off made between accuracy and run-time.

### SUMMARY

Disclosed embodiments recognize integrated circuit (IC) process levels including transistor active area and gate electrode conventionally modeled with heuristic threshold-based models that rely on Gaussian kernel coefficients generated by collecting inline data only after both resist patterning and etch lack accuracy because of the combination of resist patterning effects and etch effects. A major weakness in such conventional threshold-based modeling is recognized by disclosed embodiments to lie in the calibration of the resist portion of the model, which relies solely on Gaussian kernel-based models.

It has been recognized conventional kernel coefficients and output thresholds (either constant or variable) cannot accurately model the resist patterning processes. For instance, the process of “developing” resist is recognized herein to involves chemical “etching”, and the resulting resist loss is not accounted for in conventional threshold-based lithography models.

Algorithms disclosed herein calibrate computational lithography (CL) models individually to the individual resist patterning process step, and include a non-Gaussian developer etching kernel which represents the developer used for printing which can account for the process of chemical “etching” when developing resist, in addition to a Gaussian kernel. Disclosed developer etching kernels thus improve the accuracy of the resist model which models the resist patterning process. With disclosed algorithms, the process of modeling the resist patterning process and the etch process are separated, and since the resist model is carried into the etch model, a more accurate etch model is provided by disclosed resist models.

### BRIEF DESCRIPTION OF THE DRAWINGS

Reference will now be made to the accompanying drawings, which are not necessarily drawn to scale, wherein:

FIG. 1 is a flow chart that shows steps in an example method of CL including determining a plurality resist kernels from CD data including a non-Gaussian developer etching kernel which represents a developer used for printing, according to an example embodiment.

FIGS. 2A-F include a schematic in FIG. 2A of a test pattern used where gratings of lines bounded by assist features, and gratings of spaces are bound by the inverse features shown in FIG. 2D. The schematic also shows the progression of aerial image in FIG. 2B and in FIG. 2E with the photo-acid formation and developer loading in the resist pattern in FIG. 2C and in FIG. 2F with the change in assist feature size for lines and spaces, respectively.

FIGS. 3A and 3B show a Gaussian kernel representing acid diffusion and a disclosed subtracted Gaussian kernel representing an effect of the quencher on acid concentration during post-exposure bake.

FIG. 4 shows a test pattern used for disclosed model validation. The feature of interest for validation was in center of the array, and was asymmetrically bounded on one side by features at constant pitch and on another side with varying pitch. Additional patterns were created with placement of sub-wavelength resolution assist features (SRAF's) and near resolution assist features (NRAF's).

FIG. 5 shows residual fitting error from the validation structure plotted against the asymmetric pitch for a simulation performed.

FIG. 6 shows residual fitting error plotted against asymmetric pitch for a simulation performed.

FIG. 7 shows residual fitting error with pitch for a simulation performed.

FIG. 8 shows residual error with asymmetric pitch for a simulation using a disclosed CL model.

### DETAILED DESCRIPTION

Example embodiments are described with reference to the drawings, wherein like reference numerals are used to designate similar or equivalent elements. Illustrated ordering of acts or events should not be considered as limiting, as some acts or events may occur in different order and/or concurrently with other acts or events. Furthermore, some illustrated acts or events may not be required to implement a methodology in accordance with this disclosure.

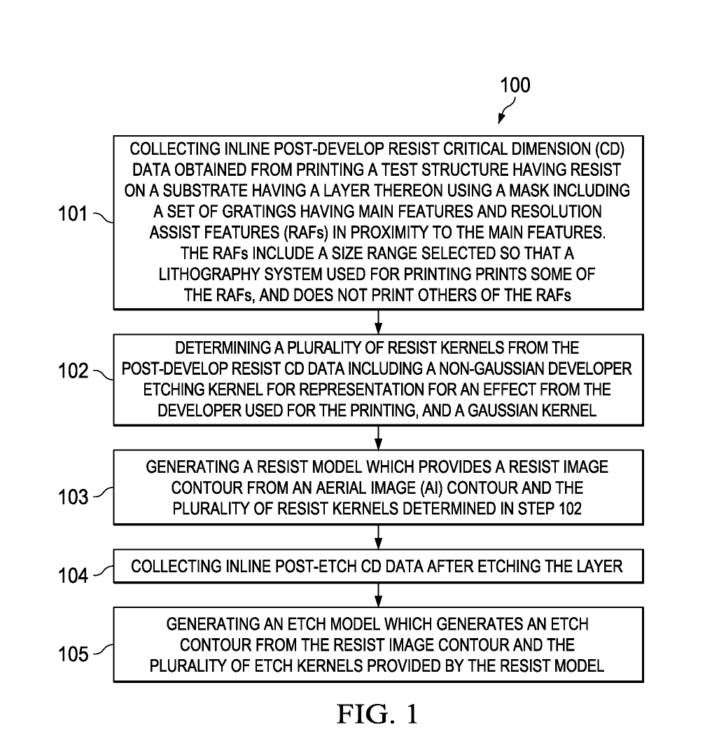

FIG. 1 is a flow chart that shows steps in an example method 100 of CL including determining a plurality resist kernels from CD data including a non-Gaussian developer etching kernel which represents a developer used for printing, according to an example embodiment. Step 101 comprises collecting inline post-develop resist CD data obtained from printing a test structure having resist on a substrate having a layer thereon using a mask including a set of gratings having main features and resolution assist features (RAFs) in proximity to the main features. The features on the grating can be lines and/or spaces. The artisan with ordinary skill in the art will appreciate that the term “mask” and “reticle” should be considered to be equivalent.

The RAFs include RAFs in a size range selected so that a lithography system (including a specific resist composition) used for printing prints some of the RAFs, and some of the RAFs do not print. The set of gratings can include gratings all having a constant pitch, with different pattern densities provided, and the size range can span from zero (nothing) to a size of the main features. As noted above, the features can be lines and/or spaces.

Step 102 comprises determining a plurality of resist kernels, using a computing device, from the post-develop resist CD data including a non-Gaussian developer etching kernel for representing an effect from the developer used for the printing, and a Gaussian kernel. The Gaussian kernel can include a representation for an effect of a base quencher to a photoacid generator in the resist.

The method can further comprise scaling/assigning relative weights to the post-develop resist CD data, wherein the determining can comprises minimizing a figure of merit (FOM) based on a standard deviation of a weighted residual error of the post-develop resist CD data. The post-develop resist CD data inherently includes the exposure variance.

The non-Gaussian developer etching kernel can be in the form of an Arrhenius relation. Equation 1 below describes a develop process, using a modified Arrhenius equation, as a function of pattern density:

exp^{(Rate x (1-Pr))} (1)

where Pr is an exportable 2D-convolution object generated by convolving a disk kernel of radius r over a pattern, and Rate is a fitting parameter that is regressed empirically along with r. Alternatively, the 2D-convolution object representing Pr can be obtained from a Gaussian kernel where σ of the Gaussian kernel replaces r in the above convolving.

Step 103 comprises generating a resist model which provides a resist image contour from an aerial image (AI) contour and the plurality of resist kernels determined in step 102. Step 104 comprises collecting inline post-etch CD data after etching the layer, such as a layer comprising polysilicon, metal, or a dielectric material. Step 105 comprises generating an etch model which generates an etch contour from the resist image contour and the plurality of etch kernels provided by the resist model.

CL can be performed using the etch model to design a reticle for at least one level for fabricating an IC. The resist model may be represented in the following form, expressing the Resist Image Contour as a function (f) of several terms as shown below:

Resist Image Contour=f(AI*GA_{D}+Mask*(modified Arrhenius equation), or simplifying:

Resist Image Contour=Aerial Image (AI) Contour+Developer Bias Kernels

Where AI is the aerial image, GA_{D} is a photoacid term obtained from Data type 2 described below, and Mask*(modified Arrhenius equation) represents developer loading. The term “developer bias kernels” in the simplified equation form shown above includes (i) a disclosed non-Gaussian developer etching kernel which represents a developer used for the printing and (ii) a conventional Gaussian kernel.

An example resist model calibration procedure is now provided. Thresholds are extracted using Data Type 1 defined as lines (or spaces) of varying spacing. Structures to generate Data type 1 are known. Regression is used to determine the developer bias kernels using Data Type 2.

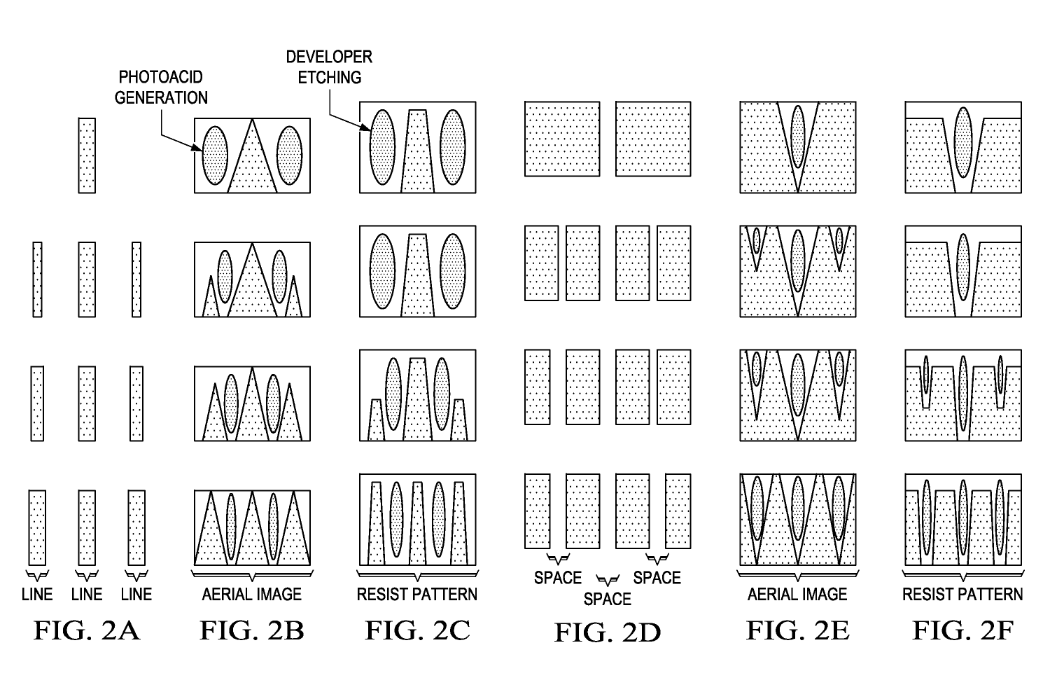

Data type 2 is obtain from disclosed test structures having set of gratings (lines or spaces) having main features and RAFs in proximity to the main features, wherein the RAFs include RAFs a size range selected so that a lithography system used for the printing prints some of the RAFs, and does not print others of the RAFs. See FIG. 2A for a reticle for a line pattern in a simplified example test structure for generating Data type 2, along with the resulting Aerial/Resist image showing photoacid generation (FIG. 2B), and the resist image showing developer etching (see FIG. 2C). In FIG. 2A, the main (center) feature (line) is held constant in size while the size of the SRAFs can be seen to increase as one moves upward in the FIG. from the same size as the main feature, to not being present. FIG. 2A thus creates dense and sparse test structures, with the main features bounded with RAF's of different sizes; ranging from sub-resolution to full resolution (same size as the main feature).

The final threshold (Gaussian Diffusion Kernel(s)) are then fine tuned using Data Type 1 or the entire data-set (Data type 1 and Data type 2). For example, a Transmission Cross Coefficient (TCC) matrix where the AI is represented as a Bessel function may be used for fine tuning to determine the final thresholds.

Data is collected using Data Type 2 after etch of the layer exposed by the resist pattern, such as after a plasma (or wet) etch. An example etch model has the following form, where the etch contour is a function of the resist image contour described above (AI Contour+Developer Bias Kernels):

ETCH Contour=f(Resist Image Contour+Mask*EtchKernels), or simplifying:

ETCH Contour=Resist Image Contour+Etch Bias Kernels

The etch (or “etch bias”) kernel(s) can be represented as conventional Gaussian kernel(s), and/or include one or more non-Gaussian etch kernels. Non-Gaussian etch kernels may be determined analogously to the non-Gaussian developer etching kernel as described above.

### EXAMPLES

Disclosed embodiments are further illustrated by the following specific Examples, which should not be construed as limiting the scope or content of this Disclosure in any way.

As described below, the CL simulator comprising an aerial image convolved with Gaussian diffusion was enhanced with addition of base quencher term to the acid diffusion and developer loading kernels. The relative importance of these kernels was demonstrated by model regression with these kernels against one data-set and validating the result against an independent data-set. The presence of the bulk loading kernel was determined to be significant in not only lowering the simulation FOM, but also in resulting model predictability that was valid beyond the region of the collected empirical (inline) data.

This Example utilized an independent data-set to extract the resist parameters to simplify the procedure while improving the accuracy and portability of the generated resist model. Whenever possible, the goal was to minimize changes to the existing model form to facilitate use in existing correction algorithms with no or minimal change to provide portability. Besides introducing developer loading parameters, the acid-quencher diffusion model was also considered to replace a conventional straight Gaussian diffusion kernel. As the sampling data for both these effects is complementary and the procedure for the simulator to extract all these parameters is purely statistical, it is possible and helpful to simultaneously extract both of these terms.

A set of gratings comprising lines were generated as shown in FIG. 2A, along with the AI in FIG. 2B, and the resulting resist pattern in FIG. 2C. The main feature spacing was designed to lie beyond the ambit of what would be expected from a true optical diffraction theory, as shown in FIG. 2A for lines. Several gratings were generated where the main feature proximity was further modulated by placement of a range of SRAF's and NRAF's at a constant spacing (pitch). Modulating the size of the assist features was found to result in varying the amount of photo-acid that was generated adjacent to the main feature. For SRAF's, the photoacid formation varied while maintaining a constant developer loading. Simultaneous variation in photo acid and developer loading occurred for NRAF's.

Similarly, an inverse of this module (features being spaces) was also created as shown in FIG. 2D, along with along with the AI in FIG. 2E, and resulting resist pattern in FIG. 2F. The regression of the diffusion and loading kernels over a suite of these structures was found to allow for precise determination of the photoacid and developer loading model parameters.

Regarding kernel formation, the threshold based model form was enhanced to account for chemically amplified resists enhanced with base quencher and developer loading to improve simulation accuracy. The optical model was represented with the minimum number of kernels required to describe convolution of an AI over a pattern using the Synopsys PROGEN package (Synopsys Corp, Mountain View, Calif.). The reduction in fitting error, where necessary, was achieved with the addition of kernels tuned specifically to a free parameter representing a process effect. In this manner, the deterministic form of the model was retained which opened the possibility to make the model portable.

The quencher influences the photoacid concentration both during formation (exposure) and diffusion during post-exposure bake. The possibility of acid volatility and its re-deposition (chemical flare) was not considered independently. However, if this were indeed occurring in any significant manner, then its effect would be lumped into the density term. The diffusion process during post-exposure bake would generally be more significant for proximity modeling since it would be a longer range effect. Furthermore, diffusion has no measurable impact on photoacid generation kinetics, and therefore would maintain the simplicity of the threshold based model form. The Gaussian kernel shown as (f(x)) below was modified by subtracting a constant (truncation of diffusion length due to quencher (“quencher”)) from the kernel as shown in Equation 2 below, where the integral is evaluated from −∞ to ∞.

∫f(x)dx−quencher (2)

In the Equation 2 representation, the quencher term changes the blurring of the AI in a manner that reduces the concentration (amplitude) and diffusion length (ambit). Mathematically, this approximation describes the long range distribution of a low level base concentration. Alternately, an additional long range Gaussian kernel to represent the long range distribution of a low level base concentration could be used. However, since its impact was identical, it was dropped due to increase in run time.

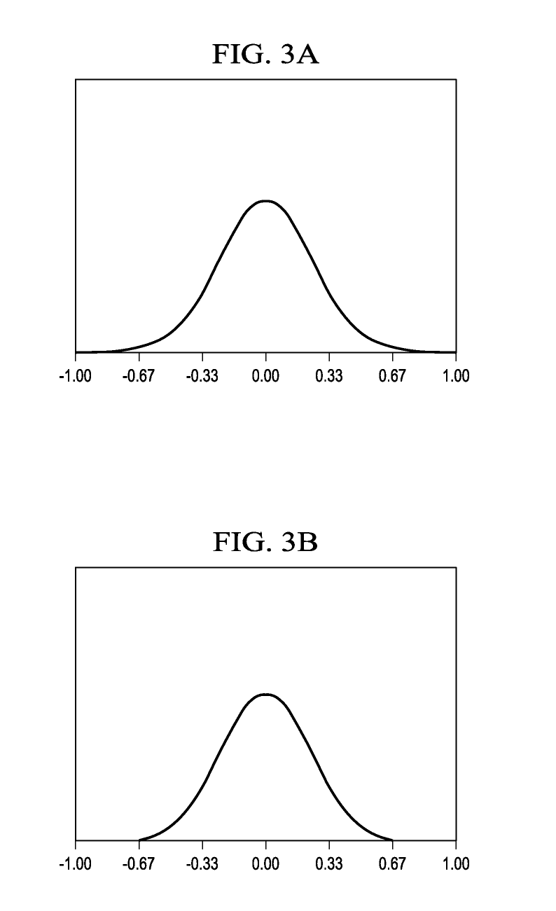

The relative comparison of both these kernels is shown in FIG. 3A and FIG. 3B demonstrating the clipping of the Gaussian distribution due to the presence of quencher term in Equation 2 in FIG. 3B where the x-axis is the distance of interaction and the y-axis is amplitude. The kernel was truncated at 0.67 μm in FIG. 3B (as compared to the kernel in FIG. 3B), while the base kernel is seen to extend to about 1 μm.

The other kernel introduced was to replicate the effect of developer with varying pattern density. Physically, the effect of developer represents removal of the resin that has been modified by the photoacid, by a base. This effect is known to be a function of resist and developer chemistry, and physical conditions such as temperature and time. For purpose of computational lithography it is generally sufficient to capture only the final state of the resist pattern as a function of density. Ideally, this could be represented by modeling it as the process of resist removal such as in an etching process. However, it can be sufficient to investigate this simply as a problem of threshold modification. The threshold modification was considered by superposition of independent effects, in this case developer loading, to the optical model form. This concept can also be extended to other density effects such as etch loading or substrate (e.g., Si) loss during surface cleaning by chemical or other (e.g., thermal) means.

A disk or cylindrical kernel was chosen to detect pattern density. Convolving a disk kernel with a pattern data removes those portions of the kernel where no pattern exists or vice versa. This is a simplified way to model a variation in feature size as function of pattern density.

Equation 1 (disclosed above, copied again below) describes the develop process, using a modified Arrhenius equation, as a function of pattern density:

exp^{(-Rate x (1-Pr))} (1)

where Pr is an exportable 2D-convolution object generated by convolving a disk of radius r over a pattern, and Rate is a fitting parameter that is regressed empirically along with r. However, as described above, alternatively, the 2D-convolution object representing Pr can be obtained from Gaussian kernel where σ of the Gaussian kernel replaces r in the convolving. Two kernels were used, one with a large radius representing the bulk effect of developer and one with short radius representing a reduced (or enhanced) rate for tight (closely spaced) features either due localized developer depletion and/or surface tension/capillary action for the resist/developer system.

As expected, the short-range kernel would be mapping local (micro-loading) effects such as surface tension while the longer range kernel would represent the bulk loading effects. One could add additional kernels depending on the pattern interaction range of available empirical data.

If a precise and transportable resist model were available, then the process of generating analog components could be automated. Besides the clear advantages in availability of a precise and compact CL model, such a CL model could also form the foundation for etch correction using staged etch models and for model-based validation work.

Disclosed models were regressed using inline data collected from a set of structures described in FIGS. 2A (lines) and FIG. 2D (spaces). The figure of merit (FOM) that was minimized during calibration was the standard deviation of the weighted residual CD error. All data points were scaled by assigning relative weights using a method that has been described previously by the Inventor that reduces influence of data points as a function of the magnitude of their variation with respect to a nominal (e.g., median) value for the data type (see Parikh, A., “Fast and accurate calibration for OPC process-window model using inverse weight algorithm”, Proc. Of SPIE Vol. 7971, 79710P (2011)).

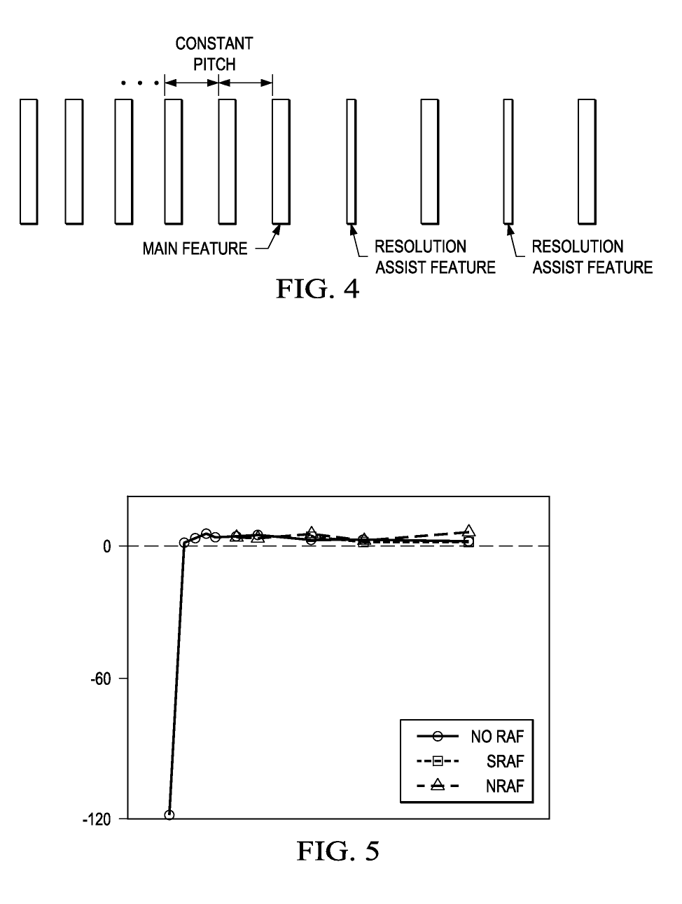

Since the goal of the calibration process was to accurately extract physical constants to form a deterministic model, rather than to minimize fitting error, minimizing the standard deviation of residual error was chosen as the FOM to avoid convergence to points with the highest residual error. To test this hypothesis and the fit of the extracted parameters, the models were validated on an independent data set using the test structures obtained using the grating shown in FIG. 4. The validation pattern of the test structure included a grating where the main (center) feature shown was asymmetrically bounded by RAF features (lines) at constant pitch on one side and of a varying pitch on its other side. The same structures were replicated with addition of SRAF's and NRAF's where permissible.

Data from the validation pattern was not used in any form during the calculation of empirical error. The experimental matrix with the included parameters regressed in this Example was compiled in Table 1 shown below. No attempt was made to change the imaging parameters. Instead, as and when needed, additional developer loading kernels were added.

| | Kernel Used | | | | |
|---|---|---|---|---|---|
| | Gaussian | | Surface | Bulk | FOM |
| Simulation | Diffusion | Quencher | Load | Load | (nm) |
| 1 | Yes | No | No | No | 3.75 |
| 2 | Yes | Yes | No | No | 3.54 |
| 3 | Yes | No | Yes | No | 3.23 |
| 4 | Yes | No | No | Yes | 2.29 |
| 5 | Yes | No | Yes | Yes | 2.19 |
| 6 | Yes | Yes | Yes | Yes | 2.13 |

Table 1 shows the design of experiment matrix with the relative importance of the additional kernels (parameters) to the model, including a surface loading kernel and a bulk loading kernel. The FOM decreased significantly from 3.75 nm for a model with only a conventional Gaussian diffusion kernel (simulation 1) to 2.29 nm with the addition of a disclosed bulk loading kernel (simulation 4). While this in itself was a significant improvement in fitting, the validation results were of even more significance. Here, the residual fitting error was plotted with the asymmetric pitch.

FIG. 5 shows the case for simulation 1 where only Gaussian diffusion were used. The x axis represents pitch and the y-axis % fitting error in nm. The model predicted a serious anomaly for the tightest asymmetric pitch. The tightest spacing was lower than both the test structures used to collect empirical data, as well as the minimum design rule. In practice, a feature with marginal resolution capability would not be permitted in the IC design. However, a good deterministic model should be valid in regions that are beyond from where the empirical data was collected, and this structure should be a good proxy to estimate the efficacy of the generated model. Similarly, validation results for simulations 2 and 3 exhibited residual error of similar magnitude for the tightest asymmetric pitch.

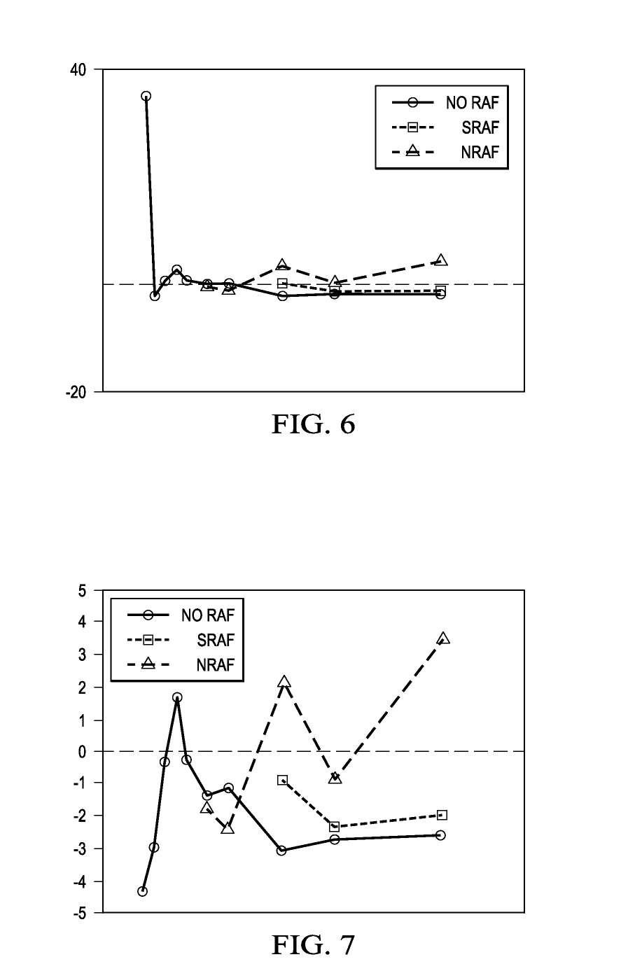

With the addition of a disclosed bulk load kernel (simulation 4), the fitting error for the same pitch was reduced by more than ⅔ from 120 nm to less than 40 nm as shown in FIG. 6, where the x axis represents pitch and the y-axis % fitting error. Based on this result and the FOM, the importance of the bulk developer loading kernel to the model fit was clearly demonstrated.

All subsequent simulations included a disclosed bulk developer loading kernel to the CL model form. To that, the surface developer loading kernel was added in simulation 5. With the addition of the surface developer loading kernel, the FOM improved from 2.29 nm to 2.19 nm. Moreover, the model validation demonstrated an acceptable fit for all points with the residual fitting error for tightest pitch being reducing from ˜40 nm to 4 nm, as can be seen in FIG. 6. No attempt was made to tune the parameters related to the AI. Were that to be attempted, one would expect reduction in the residual error in the region that lies within the ambit of optical diffraction. This data underscore the significance of extracting correct physical parameters for the resist and developer process to enable CL model portability.

This model was further enhanced by the addition of the quencher term in simulation 6. While the FOM showed further improvement, most fitting errors in the validation suite were now within 2 nm as shown in FIG. 7. Moreover, the simulator extracted a Gaussian diffusion length of 10 to 15 nm. This experiment was repeated using data collected from similar test structures from a different substrate with the same two different resist compositions. These numbers were consistent with numbers extracted from full physical simulators. One trend that was still visible was the systematic difference in the residual errors for semi-isolated pitch between the features bounded by NRAF's and those bounded by SRAF's. If the errors were completely random due to metrology noise, one would expect these errors to be scattered about zero. The developer loading kernel was thus able to improve the CL model fit.

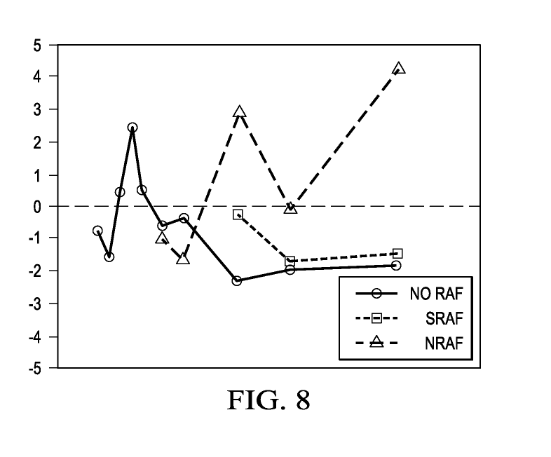

FIG. 8 shows the residual fitting error with asymmetric pitch as a function of pitch for a simulation using a disclosed CL model. All fitting errors were found to be acceptable. However, a systematic difference is seen for features bounded with NRAF's and those bounded with and without SRAF's.

Disclosed embodiments can be used for a variety of lithography systems to form semiconductor devices that may include various elements therein and/or layers thereon, including barrier layers, dielectric layers, device structures, active elements and passive elements including source regions, drain regions, bit lines, bases, emitters, collectors, conductive lines, conductive vias, etc. Those skilled in the art to which this disclosure relates will appreciate that many other embodiments and variations of embodiments are possible within the scope of the claimed invention, and further additions, deletions, substitutions and modifications may be made to the described embodiments without departing from the scope of this disclosure.

1. A method of computational lithography, comprising:
collecting inline post-develop resist critical dimension (CD) data obtained from printing a test structure having resist on a substrate having a layer thereon using a mask including a set of gratings having main features and resolution assist features (RAFs) in proximity to said main features, wherein said RAFs include a size range selected so that a lithography system used for said printing prints some of said RAFs, and does not print others of said RAFs;
determining, using a computing device, a plurality of resist kernels from said post-develop resist CD data including a non-Gaussian developer etching kernel which represents a developer used for said printing and a Gaussian kernel, and
generating a resist model using said computing device which provides a resist image contour from an aerial image contour and said plurality of resist kernels.

2. A method of claim 1, wherein said non-Gaussian developer etching kernel is in a form of an Arrhenius relation.

3. The method of claim 1, wherein said set of gratings includes gratings all having a constant pitch, gratings with different pattern density, and wherein said size range spans from zero to a size of said main features.

4. The method of claim 1, further comprising assigning relative weights to said post-develop resist CD data, wherein said determining comprises minimizing a figure of merit (FOM) based on a standard deviation of a weighted residual error of said post-develop resist CD data.

5. The method of claim 1, wherein said Gaussian kernel includes a representation for an effect of a base quencher to a photoacid generator in said resist.

6. The method of claim 1, further comprising:
collecting inline post-etch CD data after etching said layer;
determining a plurality of etch kernels from said post-etch CD data, and
generating an etch model which generates an etch contour from said resist image contour and said plurality of etch kernels.

7. The method of claim 6, further comprising performing computational lithography using said etch model to design a reticle for at least one level for fabricating an integrated circuit (IC).

8. A computer program product, comprising:
a non-transitory computer storage medium for storing algorithm instructions for computational lithography including:
determining a plurality of kernels including a non-Gaussian developer etching kernel which represents a bulk etching effect of a developer used for printing and a Gaussian kernel representing diffusion of a photoacid in resist from collected inline CD aerial image data obtained from said printing, said printing using a test structure having said resist on a substrate using a mask including a set of gratings having main features and resolution assist features (RAFs) in proximity to said main features, said RAFs including a size range selected so that a lithography system used for said printing prints some of said RAFs, and does not print others of said RAFs, and
generating a computational lithography model including said plurality of kernels.

9. The computer program product of claim 8, wherein said non-Gaussian developer etching kernel is in a form of an Arrhenius relation.

10. The computer program product of claim 8, wherein said algorithm instructions are further operable for performing computational lithography using said computational lithography model to design a reticle for at least one level for an integrated circuit (IC).
